(19) United States
(12) Patent Application Publication
(10) Pub. No.: US 2026/0211822 A1
(43) Pub. Date: Jul. 23, 2026

(54) PEAK POWER REDUCTION

(71) Applicant: Micron Technology, Inc., Boise, ID (US)

(72) Inventors: Leon Zlotnik, Camino, CA (US); Leonid Minz, Beer Sheva (IL); Liang Yu, Boise, ID (US)

(21) Appl. No.: 19/451,930

(22) Filed: Jan. 16, 2026

Related U.S. Application Data
(60) Provisional application No. 63/748,242, filed on Jan. 22, 2025.

(51) Int. Cl. G06F 13/16; G06F 11/30

(52) U.S. Cl. CPC G06F 13/1689; G06F 11/3058

(57) ABSTRACT

A system and method for reducing peak power and improving performance during data transfers on a communication bus are disclosed. The system includes a staggering controller within a system controller that manages the timing of data transfers across multiple channels by enforcing a programmable timeout between the initiation of transfers. This approach mitigates the adverse effects of simultaneous data transfers, such as transient currents, by spreading out the current demand over time. In some examples, the timing window may be dynamically adjusted based on operational metrics like temperature and power consumption.

### PRIORITY APPLICATION

This application claims the benefit of priority to U.S. Provisional Application Ser. No. 63/748,242, filed Jan. 22, 2025, which is incorporated herein by reference in its entirety.

### TECHNICAL FIELD

Embodiments pertain to power management in computing devices and components of computing devices. Some further embodiments relate to power management in memory devices such as NAND flash memory devices.

### BACKGROUND

As technology advances, the demand for higher data transfer rates and increased processing power continues to grow. These demands have led to the development of sophisticated communication buses that facilitate data transfer between various components such as processors, memory devices, and peripheral units. These communication buses enable multiple channels to operate concurrently, allowing for efficient data throughput and system performance. For example, memory systems may utilize an Open NAND Flash Interface (ONFI) bus to connect controllers to groups of NAND dies, enabling high-speed data transfers for applications ranging from consumer electronics to enterprise storage solutions. The independent operation of ONFI channels allows for simultaneous data transfers, which is beneficial for maximizing data throughput and overall system efficiency.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a timing diagram of a power transient according to some examples of the present disclosure.

FIG. 2 illustrates a timing diagram of a staggered transfer system according to some examples of the present disclosure.

FIG. 3 shows a logical diagram of a memory device according to some examples of the present disclosure.

FIG. 4 illustrates a computing system with three components according to some examples of the present disclosure.

FIG. 5 illustrates an example computing environment including a memory system, in accordance with some examples of the present disclosure.

FIG. 6 shows a flowchart of a method of staggering transactions across an interface according to some examples of the present disclosure.

FIG. 7 illustrates a block diagram of an example machine upon which any one or more of the techniques (e.g., methodologies) discussed herein may be performed according to some examples of the present disclosure.

### DETAILED DESCRIPTION

The concurrent operation of multiple channels, such as multiple ONFI bus channels, introduces complexities in power management. The dynamic nature of data transfers, coupled with the varying power demands of different operations, creates problems in ensuring stable and efficient power delivery. Effective power management not only enhances system performance but also mitigates potential issues related to signal integrity, electromagnetic interference, and voltage noise within the power delivery network (PDN).

In particular, when multiple channels initiate or terminate data transfers simultaneously, they can generate significant transient currents. These transient currents can lead to a host of issues, including signal integrity (SI) problems, increased electromagnetic interference, and voltage noise within the power delivery network (PDN). Such disturbances can degrade system performance, cause data errors, and necessitate additional design considerations to mitigate their impact, such as increased capacitance and voltage margins.

A specific example of this problem can be observed in memory systems utilizing the Open NAND Flash Interface (ONFI) bus. In these systems, each ONFI channel connects the controller to a group of one or more NAND dies. These ONFI channels operate independently, and when multiple channels start or end data transfers at the same time, the resulting transient currents can be substantial. This simultaneous activity can cause severe stress on the PDN, leading to issues such as inter-channel coupling, eye shrinkage, and excessive noise. These effects are particularly pronounced in high-density memory configurations, such as solid-state drives (SSDs) with numerous channels, where the cumulative impact of transient currents can significantly impair system stability and performance. Addressing these transient current issues ensures reliable operation and optimal performance of memory systems and other computing devices that rely on communication buses for data transfer.

Disclosed in some examples are methods, systems, devices, and machine-readable mediums which address the problem of transient currents in communication buses by introducing a staggering controller component within a system controller to manage the timing of data transfers. The staggering controller mitigates the adverse effects of simultaneous data transfers across multiple channels by enforcing a programmable timeout between the initiation of transfers on different channels to stagger the start of these transfers. By spreading out the current demand over time, the invention reduces peak transient currents, thereby minimizing PDN noise, improving signal integrity, and preventing issues such as inter-channel coupling and eye shrinkage. This approach not only enhances system stability and performance but also allows for the optimization of the ONFI output buffer driver strength, leading to significant power savings.

In some examples, a stagger timeout or window is an interval enforced by a staggering controller component within the system controller. The staggering timeout or window is an amount of time between the initiation of data transfers on different channels or different channel sets. By staggering the start times of these transfers by an amount of time specified by the stagger window, the peak transient currents are spread out over time, thereby reducing the instantaneous load on the power delivery network (PDN). This approach helps to minimize PDN noise, improve signal integrity, and prevent issues such as inter-channel coupling and eye shrinkage to improve system stability and performance.

The duration of the stagger timeout or window can be prespecified, or may be dynamically determined based on several factors, including the number of already running channels, the estimated total power or current consumption, the temperature of the system, and the type of data transfer (e.g., read or write operations). For instance, the window may be set to a shorter duration for read operations and a longer duration for write operations, depending on the specific requirements of the system. Additionally, the window may be adjusted based on the number of NAND planes and the number of logical unit numbers (LUNs) per ONFI channel. Other factors such as a system speed and feedback from the NAND or ASIC voltage droop tolerance (VDT) can also influence the stagger timeout. In some examples, the size of the window may be positively correlated to the temperature of the device (e.g., the hotter the device, the longer the device waits between successive transaction initiations). Similarly, the size of the window may also be positively correlated with a current power consumption of the device (e.g., the higher the current power usage, the longer the window).

In some examples, the staggering mechanism may be applied to individual channels. That is, the initiation of a transmission to each successive channel after a first channel may be staggered. In other examples, such as in large-scale memory devices, it may be more efficient to allow multiple channels (e.g., channel groups) to start simultaneously within a specific time window. Thus, channels may be started in groups, with each group being staggered from other groups. This approach can be less aggressive and more suitable for high-density memory configurations, where limiting the stagger to a single channel per window may unnecessarily constrain performance. By dynamically adjusting the number of channels that can start simultaneously and the duration of the stagger timeout, the system can achieve a balance between reducing transient currents and maintaining optimal data throughput.

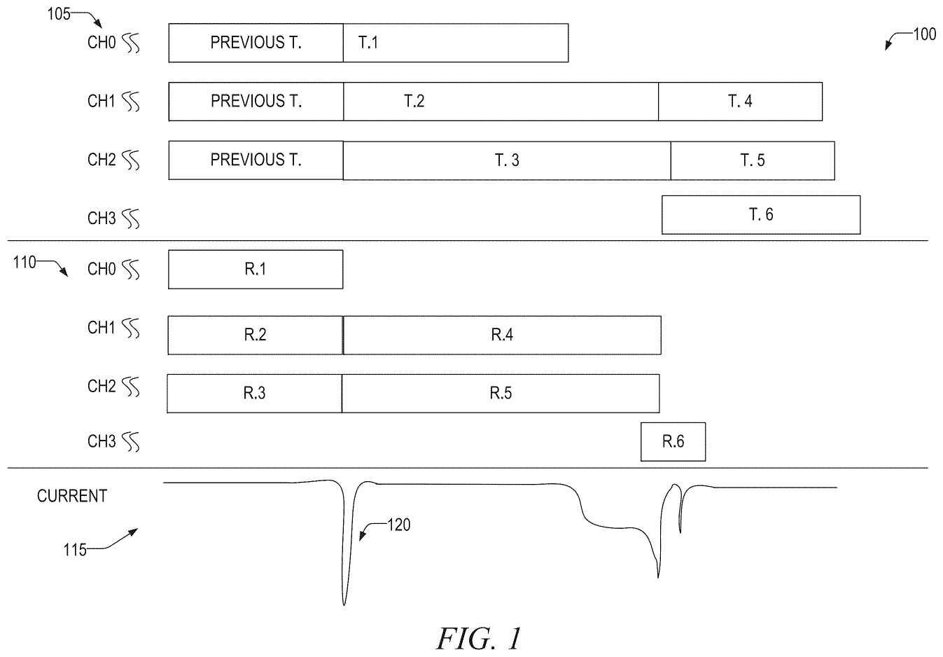

FIG. 1 illustrates a timing diagram 100 of a power transient 120 according to some examples of the present disclosure. The timing diagram 100 is a timing diagram that illustrates a sequence of transactions 105 and requests 110 as well as the associated power 115. In the example of FIG. 1, only three channels are permitted to be active due to power constraints. Requests are requests from a scheduler of the controller to a manager of the ONFI channel to begin a transaction. Transactions are the actual transactions between the ONFI channel and the memory die. In FIG. 1, when three previously initiated transactions complete, and three new transactions all start at the same time (T1, T2, and T3) on channels 0-2, the power drops and then spikes as shown at power transient 120 of the power 115.

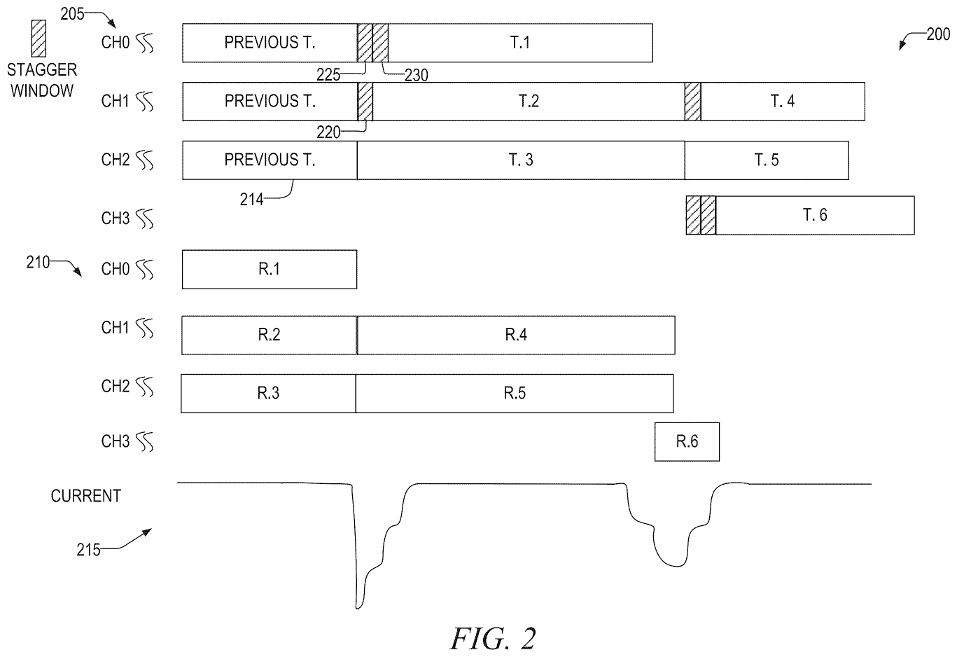

FIG. 2 illustrates a timing diagram 200 of a staggered transfer system according to some examples of the present disclosure. The timing diagram 200 is a timing diagram that illustrates a sequence of transactions 205 and requests 210 as well as the associated power 215 when the system staggers transactions. In the example of FIG. 2, only three channels are permitted to be active due to power constraints. Requests are requests from a scheduler of the controller to a manager of the ONFI channel to begin a transaction. Transactions are the actual transactions between the ONFI channel and the die. In FIG. 2, when three previously initiated transactions 214 complete, and three new transactions are ready to start, rather than beginning simultaneously, the transactions are staggered by a staggering window. Transaction 3 starts immediately, transaction 2 is staggered by a time corresponding to a single window 220 and transaction 1 is staggered by a time corresponding to an additional window (225 and 230). In examples in which more channels are permitted to be active, additional transactions that are ready to begin may be delayed by additional window lengths. This prevents two transactions from starting simultaneously. Consequently, the power 215 does not show the same spike, but rather a gradually ramp. Subsequent transactions (such as T4 and T6) are also staggered.

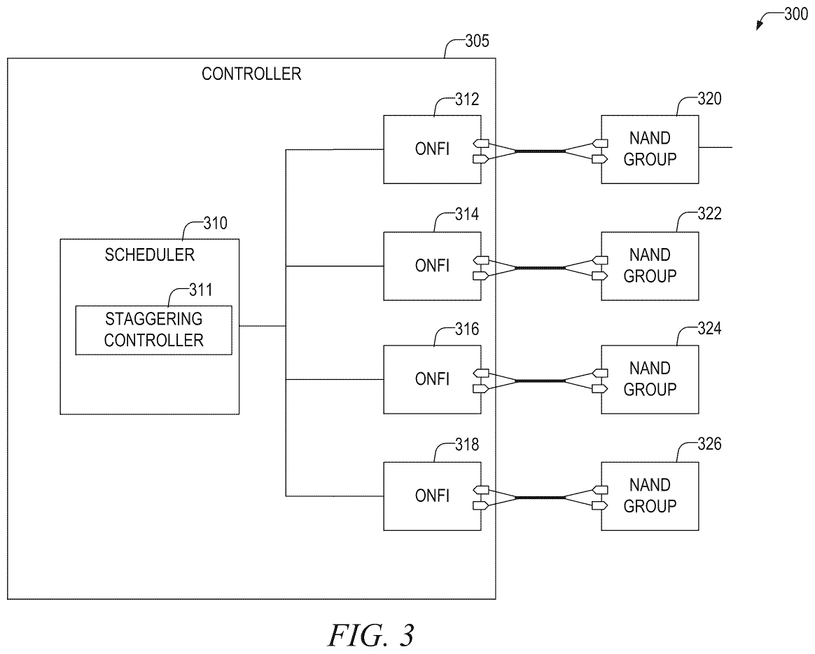

FIG. 3 shows a logical diagram of a memory device 300 according to some examples of the present disclosure. The memory device includes a controller 305 which communicates across an Open NAND Flash Interface (ONFI) to multiple NAND die groups 320-326. The controller 305 includes a scheduler 310, which is responsible for managing the communication and control of multiple ONFI channel managers 312-318. The scheduler 110 interfaces with four ONFI channel managers: ONFI Channel manager 312, ONFI Channel manager 314, ONFI Channel manager 316, and ONFI Channel manager 318. The scheduler 310 includes a staggering controller component 311 for staggering the start of transactions on one or more of the ONFI channels.

Each ONFI channel manager may manage one or more ONFI channels and may be connected to a corresponding one or more NAND dies. Specifically, in FIG. 3, ONFI Channel manager 312 controls a channel connected to a NAND Die group 320, ONFI Channel manager 314 controls a channel that is connected to NAND Die group 322, ONFI Channel manager 316 controls a channel that is connected to NAND Die group 324, and ONFI Channel manager 318 controls a channel that is connected to NAND Die group 326. NAND die groups include one or more NAND dies. These connections facilitate the transfer of data and control signals between the scheduler 310 and the NAND dies.

The scheduler 310 coordinates the operations of the ONFI channels and the NAND dies, ensuring that data transfers and power management are performed efficiently. The ONFI channel managers 312, 314, 316, and 318 handle the communication across their respective ONFI channels with the respective NAND dies within the NAND die groups 320, 322, 324, and 326, enabling the memory device 300 to perform read and write operations effectively. The scheduler 310 is responsible for scheduling requests on the ONFI channels. The ONFI channel managers then carry out the transactions.

The staggering controller component 311 may determine the timeout window. The timeout window may be statically configured or dynamically determined by the staggering controller component 311 as previously described. Scheduler 310 may schedule transactions with the ONFI managers. The ONFI managers do not immediately execute the transactions. Rather, once the ONFI bus managed by the manager is ready to perform the transaction, the ONFI channel manager 312 may send a “ready” message to the staggering controller component 311.

The staggering controller component 311 within the system controller employs an algorithm to manage the timing of data transfers across multiple channels on the communication bus. The algorithm considers several factors, including the number of currently pending transactions, the maximum number of allowable pending transactions, whether a transaction was recently started, and other ready transactions.

One example algorithm is as follows: The algorithm begins by identifying the maximum number of concurrently pending transactions (max_pending_transactions), the current count of pending transactions (pending_transactions), and the timestamp of the last initiated transaction (last_transaction_time). When a transaction ready indication is received from a channel controller, the transaction is added to an end of a ready_queue. The algorithm continuously monitors the ready_queue for pending transactions. If the number of pending transactions is less than the maximum allowable pending transactions, the algorithm proceeds to process the next transaction in the ready_queue. For each transaction, the algorithm checks if the number of pending transactions has reached the maximum limit. If so, it waits until a pending transaction completes before proceeding. Otherwise, it calculates the time elapsed since the last transaction was initiated. If the elapsed time is less than the stagger timeout, the algorithm waits for the remaining time of the stagger timeout before initiating the next transaction. Once the conditions are met, the algorithm removes the transaction from the ready_queue, sends a grant signal to the corresponding channel controller to allow the initiation of the transaction, increments the count of pending transactions, and updates the timestamp of the last initiated transaction. When a transaction completes, the algorithm decrements the count of pending transactions. If dynamic adjustments are enabled, the algorithm periodically checks system metrics such as temperature, total power consumption, and feedback from the voltage droop tolerance (VDT) component. Based on these metrics, the algorithm may adjust the stagger timeout.

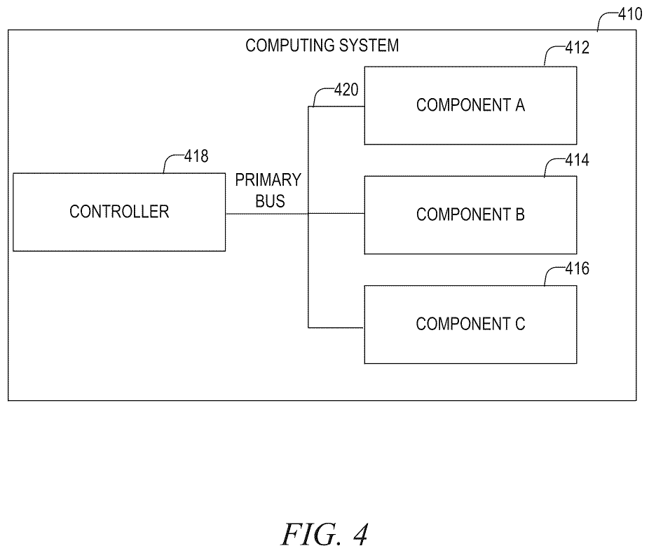

While the present disclosure has described the inventive techniques disclosed herein in the context of memory systems, a person of ordinary skill in the art will appreciate that these inventive techniques may be utilized with other systems as well. FIG. 4 illustrates a computing system 410 with three components: component A 412, component B 414, and component C 416. The three components are connected to a controller 418. The controller configures, receives status information from, and/or manages the components.

The primary bus 420 is a communication bus used primarily by the controller 418 to communicate data and operations with the components. For example, if the components are memory devices, the primary bus 420 may be used to communicate data stored in the memory devices.

Controller, component A 412, component B 414, and/or component C 416 may be software components or hardware components (e.g., logic circuits such as an Application Specific Integrated Circuit (ASIC)). In some examples, the controller, component A 412, component B 414, and/or component C 416 may be on the same device. In other examples, one or more of the components and the controller 418 may be, or be located on, different devices. In some examples, the communication bus (e.g., primary bus 420) may be a local bus such as Peripheral Component Interconnect (PCI), Universal Serial Bus, memory bus, token ring bus, ethernet bus, and the like. In other examples, the bus may be a remote bus such as those facilitating communication between devices. For example, a CXL bus.

Controller 418 may stagger the start of transactions and data sent across primary bus 420 to component A 412, component B 414, and component C 416.

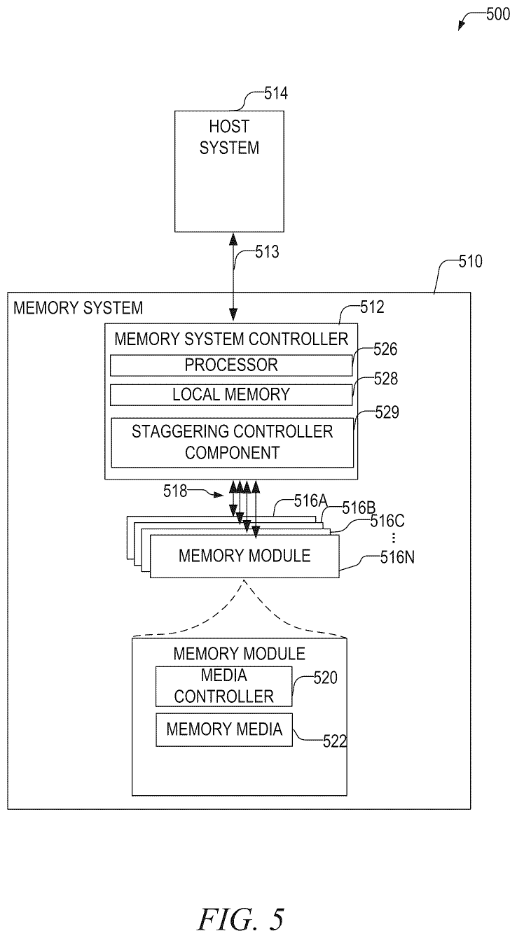

FIG. 5 illustrates an example computing environment 500 including a memory system 510, in accordance with some examples of the present disclosure. In some examples, the memory system 510 can be volatile storage such as Random Access Memory (RAM), cache memory, dynamic RAM (DRAM), synchronous DRAM (SDRAM), double data rate SDRAM (DDR), static RAM (SRAM), Graphics DDR (GDDR), or the like. In some examples, the memory system 510 can be non-volatile storage such as a Not-AND (NAND) flash, NOR flash, magnetic storage (e.g., a hard-disk drive), tape storage, or the like. In some examples, the memory system 510 can include both volatile and non-volatile storage, by utilizing, for example, memory modules 516A-N containing different types of memory media 522 or by utilizing one or more single memory modules that include both volatile and non-volatile memory media 522. The memory system 510 may be an error-correcting memory system in that at least some of the memory media 522 includes error correcting memory.

In an example, the memory system 510 can be a discrete memory and/or storage device component of a host system. In other examples, the memory system 510 can be a portion of an integrated circuit (e.g., system on a chip (SOC), etc.), stacked or otherwise included with one or more other components of a host system. In some examples, the memory system 510 may be part of a distributed memory system with multiple memory systems 510 and multiple host systems that may each include one or more processors. For example, a distributed memory system may operate according to a Compute Express Link (CXL) framework, such as a CXL. mem framework. The memory system may also have compute capabilities to support compute-near-memory functionalities-e.g., by using the processor 526 of memory system controller 512, media controller 520, or some other processor that is not shown.

As noted, the host 514, as well as memory system 510 can be integrated into a single host computing system. The host system can be in the form of a desktop computer, laptop computer, network server, mobile device, or such computing device that includes a memory and a processing device. The host system and/or the memory system 510 can be included in a variety of products, such as IoT devices (e.g., a refrigerator or other appliance, sensor, motor or actuator, mobile communication device, automobile, drone, etc.) to support processing, communications, or control of the product. The host system can include or be coupled to the host 514 and to the memory system 510 so that the host system can read data from or write data to the memory system 510. As used herein, “coupled to” generally refers to a connection between components, which can be an indirect communicative connection or direct communicative connection (e.g., without intervening components), whether wired or wireless, including connections such as, electrical, optical, magnetic, and the like.

The memory system 510 is configured with a memory system controller 512 that interfaces with the host 514. The host 514 may include a hardware processor, which may be a multi-core hardware processor, and communicates with the memory system controller 512 via a memory controller interface 513. Through this interface, the host 514 can issue commands to the memory system controller 512, such as a request to store data, which is accompanied by the data itself and potentially the target memory address for storage. In response, the memory system controller 512 can acknowledge the command and execute the data storage operation, providing confirmation back to the host 514 through the memory controller interface 513. Similarly, the host 514 can send a command to retrieve data, specifying the memory address from which to load the data. Upon receiving such a command, the memory system controller 512 retrieves the requested data and delivers it to the host 514 through the memory controller interface 513.

In certain embodiments, the host 514 and the memory system controller 512 are integrated onto a single die or different dies, but within a unified package. For example, in systems based on the x86 architecture, the memory system controller 512 is typically on the same die as the processor cores of host 514, thereby streamlining the memory access operations. Alternatively, there are configurations where the memory system controller 512 is situated on a distinct die, separate from that of the host 514 but within a same CPU package, allowing for modular design and potential customization of the memory system. In yet other examples, the memory system controller 512 may not be on the same die or package as the host 514.

The host 514 may communicate with the memory system controller 512 through a memory controller interface 513 and the memory system controller 512 may communicate with one or more memory modules 516A-516N upon which the physical memory is located through the memory module interface 518. In examples in which the memory system controller 512 is not on the same die or package as the host 514, the memory controller interface 513 may be the system bus, front-side bus, or other interface and the memory module interface 518 may be an internal bus of the memory system 510, such as internal pins or traces or some other interface such as an ONFI bus. In other examples, where the memory system controller 512 is on a same die or package as the host 514, the memory controller interface 513 may be one or more traces, pins, or some other interface and the memory module interface 518 may be a system bus.

The memory controller interface 513 and/or the memory module interface 518 may, depending on the design of the system, operate as one or more traces or pins, a Peripheral Component Interconnect-Express (PCIe) interface, a UFS interface, a serial advanced technology attachment (SATA) interface, a universal serial bus (USB) interface, an ONFI interface, a Fibre Channel interface, Serial Attached SCSI (SAS) interface, memory fabric, an eMMC interface, or the like.

The memory modules, designated as 516A through 516N, are capable of incorporating a diverse array of memory media 522, which may be either volatile or non-volatile in nature. The memory media 522 is comprised of elements such as memory cells, magnetic sectors, or equivalent data storage units. These memory modules can manifest in various configurations, including but not limited to Single Inline Memory Modules (SIMMs), Dual Inline Memory Modules (DIMMs), Solid State Drives (SSDs), embedded MultiMediaCards (eMMCs), Hard Disk Drives (HDDs), tape drives, among others. The memory media 522 within modules 516A-516N may encompass Random Access Memory (RAM), Static RAM (SRAM), Dynamic RAM (DRAM), Synchronous DRAM (SDRAM), NAND flash memory, magnetic media, phase-change memory (PCM), magneto-resistive random access memory (MRAM), NOR flash memory, electrically erasable programmable read-only memory (EEPROM), cross-point memory, and similar technologies. For instances where the memory media 522 consists of NAND-type memory, the configuration may involve a range of cell architectures, from single-level cells (SLCs) to multi-level cells (MLCs). MLCs may include triple-level cells (TLCs), quad-level cells (QLCs), and the like.

In some examples, the data storage units of the memory media 522 (such as memory cells) may be organized into one or more logical structures. For volatile storage, one example of a logical organization groups memory cells by ranks, banks, rows, and columns. For non-volatile storage, one example logical organization includes grouping cells into planes, sub-blocks, blocks, and/or pages. Other logical organizations may include sectors, tracks, cylinders, clusters, and so on.

In some examples, one or more of the memory modules 516A-516N may include a media controller 520 that may handle tasks such as accessing data from the memory media, writing data to the memory media, refreshing memory cells and communications over the memory module interface with the memory system controller 512. For example, the media controller 520 can parse a command and determine the affected memory cells from the memory media 522 and can read and/or write a desired value to those memory cells. Media controller 520 can be responsible for refreshing or otherwise maintaining the data stored in the memory media 522. In some examples, the media controller 520 may handle one or more of the functions traditionally associated with the memory system controller 512. In some examples, the memory modules 516A-N do not include a media controller 520.

The media controller 520 can include hardware such as one or more integrated circuits and/or discrete components, a buffer memory, or a combination thereof. The media controller 520 can be a microcontroller, special purpose logic circuitry (e.g., a field programmable gate array (FPGA), an application specific integrated circuit (ASIC), etc.), or other suitable processor(s). The media controller 520 can include a processor (processing device) configured to execute instructions stored in a local memory. Media controller 520 can also include address circuitry, row decoders, I/O circuitry write circuitry, column decoders, sensing circuitry, and other latches for decoding addresses, writing to, and reading from the memory media 522.

The local memory of the media controller 520 can include embedded memory configured to store instructions for performing various processes, operations, logic flows, and routines that control the memory media 522, including handling communications between the memory module 516A-516N and the memory system controller 512. In some embodiments, the local memory of the media controller 520 can include memory registers storing, e.g., memory pointers, fetched data, etc. The local memory can also include read-only memory (ROM) for storing micro-code.

The memory system controller 512 (controller) can include a processor 526 configured to execute instructions stored in a local memory 528. The processor 526 can be a microcontroller, special purpose logic circuitry (e.g., a field programmable gate array (FPGA), an application specific integrated circuit (controller), etc.), general purpose processor configured by software (e.g., firmware), or other suitable processor. In the illustrated example, the local memory 528 may store instructions for performing various processes, operations, logic flows, and routines that control operation of the memory system 510, including handling communications between the memory system 510 and the host 514 and communications between the memory system controller 512 and the memory modules 516A-516N. In some embodiments, the local memory 528 of the memory system controller 512 can include memory registers storing, e.g., memory pointers, fetched data, etc. The local memory can also include read-only memory (ROM) for storing micro-code.

Local memory 528 may also include various management tables such as translation tables translating logical addresses used by the host 514 into physical memory addresses that define a physical location of the memory cells. In other examples, the management tables can instead or additionally include information regarding block age, block erase count, error history, or one or more error counts (e.g., a write operation error count, a read bit error count, a read operation error count, an erase error count, etc.) for one or more blocks of memory cells coupled to the memory system controller 512.

As noted, the memory system controller 512 can receive commands or operations (memory access commands) from the host 514 (or other component of a host) and can convert the commands or operations into instructions or appropriate commands to achieve the desired access to the memory modules 516A to 516N. The memory system controller 512 can be responsible for other operations such as wear leveling operations (e.g., garbage collection operations, reclamation), error detection and error-correcting code (ECC) operations, refresh operations, encryption operations, caching operations, block retirement, and address translations between a logical block address and a physical block address that are associated with the memory modules 516A to 516N. The memory system controller 512 can further include interface circuitry to communicate with the processor via the memory controller interface 513. The interface circuitry can convert the commands received from the host 514 into command instructions to access the memory modules 516A to 516N over the memory module interface 518 as well as convert responses associated with the memory modules 516A to 516N into information for the host 514 or other component of the host system.

The memory system controller 512 may include or be coupled to a staggering controller component 529. In some examples, the staggering controller component 529 may be an example of staggering controller component 311 of FIG. 3. Staggering controller component 311 may stagger the initiation of transfers of data across memory module interface 518 as described herein to limit power surges.

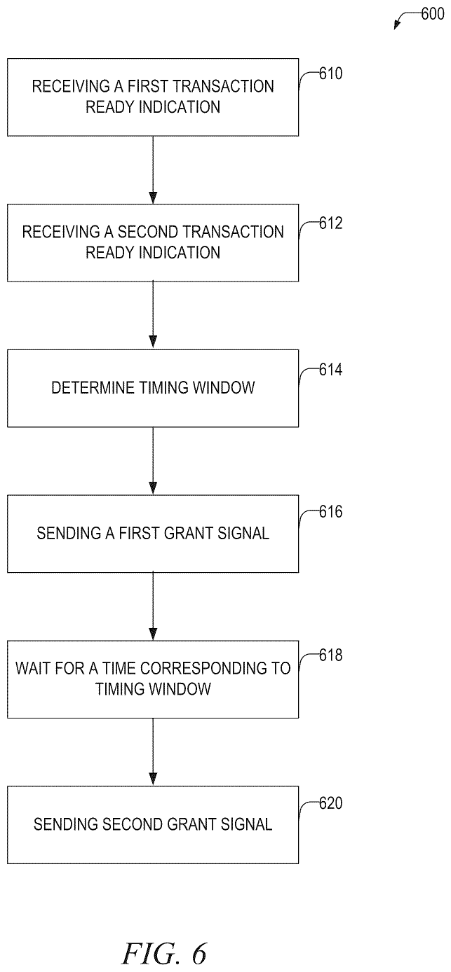

FIG. 6 shows a flowchart of a method 600 of staggering transactions across an interface according to some examples of the present disclosure. The method 600 begins with receiving a first transaction ready indication at operation 610. This step involves the staggering controller in the system controller receiving a signal from a first channel controller indicating that a first transaction is ready to be initiated over a first channel on the communication bus.

Next, the method proceeds to receiving a second transaction ready indication at operation 612. In this step, the staggering controller receives a signal from a second channel controller indicating that a second transaction is ready to be initiated over a second channel on the communication bus.

Following the receipt of the transaction ready indications, the method involves determining a timing window at operation 614. The staggering controller determines a timing window for staggering the first transaction and the second transaction to prevent the first and second transactions from being initiated at the same time. This timing window can be either static or dynamically adjusted based on various operational metrics such as temperature, estimated total power consumption, and the number of already running channels.

Once the timing window is determined, the method includes sending a first grant signal at operation 616. The staggering controller sends a grant signal to the first channel controller to allow the initiation of the first transaction. The grant signal causes the first channel controller to begin the first transaction.

The method then involves waiting for a time corresponding to the timing window at operation 618. The staggering controller waits for an amount of time that corresponds to the previously determined timing window before proceeding to the next step.

The method concludes with sending a second grant signal at operation 620. After waiting for the specified time, the staggering controller sends a second grant signal to the second channel controller to allow the initiation of the second transaction. The grant signal causes the second channel controller to begin the second transaction.

This method effectively staggers the initiation of transactions across multiple channels, thereby reducing peak transient currents and minimizing power delivery network noise, improving signal integrity, and preventing issues such as inter-channel coupling and eye shrinkage.

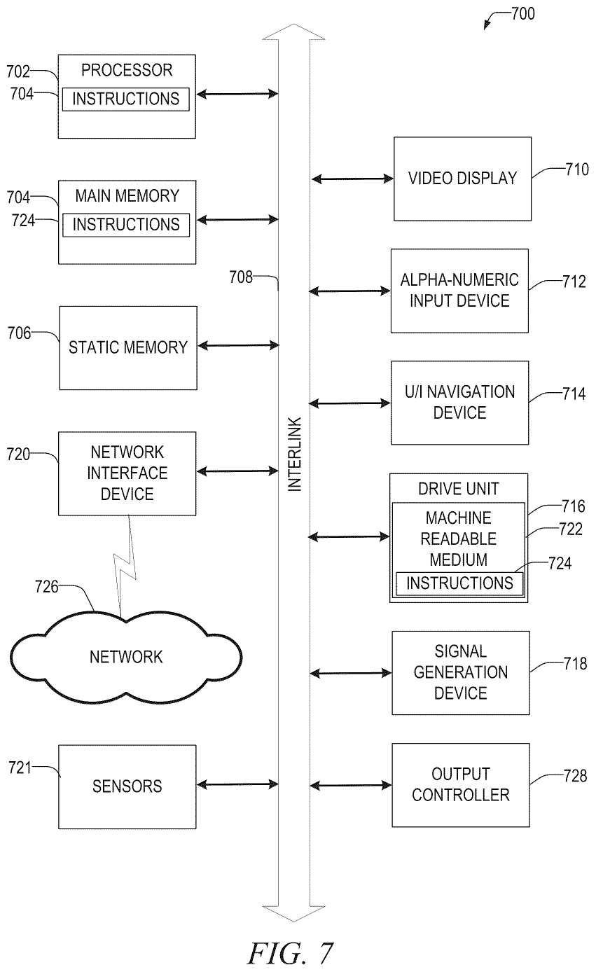

FIG. 7 illustrates a block diagram of an example machine 700 upon which any one or more of the techniques (e.g., methodologies) discussed herein may be performed. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be in the form of a memory device, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 700 may implement the timing diagrams of FIGS. 1 and 2; the system of FIGS. 3 and 4; the memory system of FIG. 5; and the method of FIG. 6.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 700 may include one or more hardware processors, such as processor 702. Processor 702 may be a central processing unit (CPU), a graphics processing unit (GPU), a hardware processor core, or any combination thereof. Machine 700 may include a main memory 704 and a static memory 706, some or all of which may communicate with each other via an interlink (e.g., bus) 708. Examples of main memory 704 may include Synchronous Dynamic Random-Access Memory (SDRAM), such as Double Data Rate memory, such as DDR4 or DDR5. Interlink 708 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 724 may further be transmitted or received over a communications network 726 using a transmission medium via the network interface device 720. The Machine 700 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

### Other Notes and Examples

Example 1 is a method for reducing peak power and improving performance during data transfers on a communication bus, the method comprising: at a system controller: receiving a first transaction ready indication from a first channel controller indicating that a first transaction is ready to be initiated over a first channel on the communication bus; receiving a second transaction ready indication from a second channel controller indicating that a second transaction is ready to be initiated over a second channel on the communication bus; determining a timing window for staggering the first transaction and the second transaction to prevent the first and second transactions from being initiated at a same time; sending a first grant signal to the first channel controller to allow the initiation of the first transaction, wherein the first grant signal causes the first channel controller to begin the first transaction; and waiting an amount of time corresponding to the timing window, and afterwards, sending a second grant signal to the second channel controller to allow the initiation of the second transaction, wherein the second grant signal causes the second channel controller to begin the second transaction.

In Example 2, the subject matter of Example 1 includes, wherein the communication bus is an Open NAND Flash Interface (ONFI) and the system controller is a memory system controller.

In Example 3, the subject matter of Examples 1-2 includes, dynamically adjusting the timing window for staggering the first transaction and the second transaction based on an operational metric of the system controller.

In Example 4, the subject matter of Example 3 includes, wherein the operational metric of the system controller comprises a temperature indication and wherein a length of the timing window is positively correlated to the temperature indication.

In Example 5, the subject matter of Examples 3-4 includes, wherein the operational metric of the system controller comprises an estimated total power consumption of the system controller, wherein a length of the timing window is positively correlated to estimated total power consumption.

In Example 6, the subject matter of Examples 1-5 includes, receiving a third transaction ready indication from a third channel controller indicating that a third transaction is ready to be initiated over a third channel on the communication bus; and sending a third grant signal to the third channel controller to allow the initiation of the third transaction, the third grant signal sent prior to waiting the amount of time and allowing initiation of the first and third transactions at a same time.

In Example 7, the subject matter of Examples 1-6 includes, wherein the timing window is a static interval preconfigured in the system controller.

Example 8 is a computing device for reducing peak power and improving performance during data transfers on a communication bus, the computing device comprising: a hardware processor; a memory, the memory storing instructions, which when executed by the hardware processor cause the computing device to perform operations comprising: receiving a first transaction ready indication from a first channel controller indicating that a first transaction is ready to be initiated over a first channel on the communication bus; receiving a second transaction ready indication from a second channel controller indicating that a second transaction is ready to be initiated over a second channel on the communication bus; determining a timing window for staggering the first transaction and the second transaction to prevent the first and second transactions from being initiated at a same time; sending a first grant signal to the first channel controller to allow the initiation of the first transaction, wherein the first grant signal causes the first channel controller to begin the first transaction; and waiting an amount of time corresponding to the timing window, and afterwards, sending a second grant signal to the second channel controller to allow the initiation of the second transaction, wherein the second grant signal causes the second channel controller to begin the second transaction.

In Example 9, the subject matter of Example 8 includes, wherein the communication bus is an Open NAND Flash Interface (ONFI) and the system controller is a memory system controller.

In Example 10, the subject matter of Examples 8-9 includes, wherein the operations further comprise dynamically adjusting the timing window for staggering the first transaction and the second transaction based on an operational metric of the system controller.

In Example 11, the subject matter of Example 10 includes, wherein the operational metric of the system controller comprises a temperature indication and wherein a length of the timing window is positively correlated to the temperature indication.

In Example 12, the subject matter of Examples 10-11 includes, wherein the operational metric of the system controller comprises an estimated total power consumption of the system controller, wherein a length of the timing window is positively correlated to estimated total power consumption.

In Example 13, the subject matter of Examples 8-12 includes, wherein the operations further comprise: receiving a third transaction ready indication from a third channel controller indicating that a third transaction is ready to be initiated over a third channel on the communication bus; and sending a third grant signal to the third channel controller to allow the initiation of the third transaction, the third grant signal sent prior to waiting the amount of time and allowing initiation of the first and third transactions at a same time.

In Example 14, the subject matter of Examples 8-13 includes, wherein the timing window is a static interval preconfigured in the system controller.

Example 15 is a non-transitory machine-readable medium, storing instructions for reducing peak power and improving performance during data transfers on a communication bus, the instructions, which when executed, cause the machine to perform operations comprising: receiving a first transaction ready indication from a first channel controller indicating that a first transaction is ready to be initiated over a first channel on the communication bus; receiving a second transaction ready indication from a second channel controller indicating that a second transaction is ready to be initiated over a second channel on the communication bus; determining a timing window for staggering the first transaction and the second transaction to prevent the first and second transactions from being initiated at a same time; sending a first grant signal to the first channel controller to allow the initiation of the first transaction, wherein the first grant signal causes the first channel controller to begin the first transaction; and waiting an amount of time corresponding to the timing window, and afterwards, sending a second grant signal to the second channel controller to allow the initiation of the second transaction, wherein the second grant signal causes the second channel controller to begin the second transaction.

In Example 16, the subject matter of Example 15 includes, wherein the communication bus is an Open NAND Flash Interface (ONFI) and the system controller is a memory system controller.

In Example 17, the subject matter of Examples 15-16 includes, wherein the operations further comprise dynamically adjusting the timing window for staggering the first transaction and the second transaction based on an operational metric of the system controller.

In Example 18, the subject matter of Example 17 includes, wherein the operational metric of the system controller comprises a temperature indication and wherein a length of the timing window is positively correlated to the temperature indication.

In Example 19, the subject matter of Examples 17-18 includes, wherein the operational metric of the system controller comprises an estimated total power consumption of the system controller, wherein a length of the timing window is positively correlated to estimated total power consumption.

In Example 20, the subject matter of Examples 15-19 includes, wherein the operations further comprise: receiving a third transaction ready indication from a third channel controller indicating that a third transaction is ready to be initiated over a third channel on the communication bus; and sending a third grant signal to the third channel controller to allow the initiation of the third transaction, the third grant signal sent prior to waiting the amount of time and allowing initiation of the first and third transactions at a same time.

In Example 21, the subject matter of Examples 15-20 includes, wherein the timing window is a static interval preconfigured in the system controller.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A method for reducing peak power and improving performance during data transfers on a communication bus, the method comprising:
at a system controller:
receiving a first transaction ready indication from a first channel controller indicating that a first transaction is ready to be initiated over a first channel on the communication bus;
receiving a second transaction ready indication from a second channel controller indicating that a second transaction is ready to be initiated over a second channel on the communication bus;
determining a timing window for staggering the first transaction and the second transaction to prevent the first and second transactions from being initiated at a same time;
sending a first grant signal to the first channel controller to allow the initiation of the first transaction, wherein the first grant signal causes the first channel controller to begin the first transaction; and
waiting an amount of time corresponding to the timing window, and afterwards, sending a second grant signal to the second channel controller to allow the initiation of the second transaction, wherein the second grant signal causes the second channel controller to begin the second transaction.

2. The method of claim 1, wherein the communication bus is an Open NAND Flash Interface (ONFI) and the system controller is a memory system controller.

3. The method of claim 1, further comprising dynamically adjusting the timing window for staggering the first transaction and the second transaction based on an operational metric of the system controller.

4. The method of claim 3, wherein the operational metric of the system controller comprises a temperature indication and wherein a length of the timing window is positively correlated to the temperature indication.

5. The method of claim 3, wherein the operational metric of the system controller comprises an estimated total power consumption of the system controller, wherein a length of the timing window is positively correlated to estimated total power consumption.

6. The method of claim 1, further comprising:
receiving a third transaction ready indication from a third channel controller indicating that a third transaction is ready to be initiated over a third channel on the communication bus; and
sending a third grant signal to the third channel controller to allow the initiation of the third transaction, the third grant signal sent prior to waiting the amount of time and allowing initiation of the first and third transactions at a same time.

7. The method of claim 1, wherein the timing window is a static interval preconfigured in the system controller.

8. A computing device for reducing peak power and improving performance during data transfers on a communication bus, the computing device comprising:
a hardware processor;
a memory, the memory storing instructions, which when executed by the hardware processor cause the computing device to perform operations comprising:
receiving a first transaction ready indication from a first channel controller indicating that a first transaction is ready to be initiated over a first channel on the communication bus;
receiving a second transaction ready indication from a second channel controller indicating that a second transaction is ready to be initiated over a second channel on the communication bus;
determining a timing window for staggering the first transaction and the second transaction to prevent the first and second transactions from being initiated at a same time;
sending a first grant signal to the first channel controller to allow the initiation of the first transaction, wherein the first grant signal causes the first channel controller to begin the first transaction; and
waiting an amount of time corresponding to the timing window, and afterwards, sending a second grant signal to the second channel controller to allow the initiation of the second transaction, wherein the second grant signal causes the second channel controller to begin the second transaction.

9. The computing device of claim 8, wherein the communication bus is an Open NAND Flash Interface (ONFI) and the system controller is a memory system controller.

10. The computing device of claim 8, wherein the operations further comprise dynamically adjusting the timing window for staggering the first transaction and the second transaction based on an operational metric of the system controller.

11. The computing device of claim 10, wherein the operational metric of the system controller comprises a temperature indication and wherein a length of the timing window is positively correlated to the temperature indication.

12. The computing device of claim 10, wherein the operational metric of the system controller comprises an estimated total power consumption of the system controller, wherein a length of the timing window is positively correlated to estimated total power consumption.

13. The computing device of claim 8, wherein the operations further comprise:
receiving a third transaction ready indication from a third channel controller indicating that a third transaction is ready to be initiated over a third channel on the communication bus; and
sending a third grant signal to the third channel controller to allow the initiation of the third transaction, the third grant signal sent prior to waiting the amount of time and allowing initiation of the first and third transactions at a same time.

14. The computing device of claim 8, wherein the timing window is a static interval preconfigured in the system controller.

15. A non-transitory machine-readable medium, storing instructions for reducing peak power and improving performance during data transfers on a communication bus, the instructions, which when executed, cause the machine to perform operations comprising:
receiving a first transaction ready indication from a first channel controller indicating that a first transaction is ready to be initiated over a first channel on the communication bus;
receiving a second transaction ready indication from a second channel controller indicating that a second transaction is ready to be initiated over a second channel on the communication bus;
determining a timing window for staggering the first transaction and the second transaction to prevent the first and second transactions from being initiated at a same time;
sending a first grant signal to the first channel controller to allow the initiation of the first transaction, wherein the first grant signal causes the first channel controller to begin the first transaction; and
waiting an amount of time corresponding to the timing window, and afterwards, sending a second grant signal to the second channel controller to allow the initiation of the second transaction, wherein the second grant signal causes the second channel controller to begin the second transaction.

16. The machine-readable medium of claim 15, wherein the communication bus is an Open NAND Flash Interface (ONFI) and the system controller is a memory system controller.

17. The machine-readable medium of claim 15, wherein the operations further comprise dynamically adjusting the timing window for staggering the first transaction and the second transaction based on an operational metric of the system controller.

18. The machine-readable medium of claim 17, wherein the operational metric of the system controller comprises a temperature indication and wherein a length of the timing window is positively correlated to the temperature indication.

19. The machine-readable medium of claim 17, wherein the operational metric of the system controller comprises an estimated total power consumption of the system controller, wherein a length of the timing window is positively correlated to estimated total power consumption.

20. The machine-readable medium of claim 15, wherein the operations further comprise:
receiving a third transaction ready indication from a third channel controller indicating that a third transaction is ready to be initiated over a third channel on the communication bus; and
sending a third grant signal to the third channel controller to allow the initiation of the third transaction, the third grant signal sent prior to waiting the amount of time and allowing initiation of the first and third transactions at a same time.
